(19) United States
(12) Patent Application Publication
(10) Pub. No.: US 2026/0197766 A1
(43) Pub. Date: Jul. 9, 2026

(54) RECEIVING PERFORMANCE TEST METHOD AND APPARATUS, TERMINAL, AND NETWORK SIDE DEVICE

(71) Applicant: VIVO MOBILE COMMUNICATION CO., LTD., Guangdong (CN)

(72) Inventors: Ruixin WANG, Guangdong (CN); Xin QU, Guangdong (CN); Li CHEN, Guangdong (CN); Xueming PAN, Guangdong (CN)

(73) Assignee: VIVO MOBILE COMMUNICATION CO., LTD., Guangdong (CN)

(21) Appl. No.: 19/558,121

(22) Filed: Mar. 5, 2026

Related U.S. Application Data
(63) Continuation of application No. PCT/CN2024/116189, filed on Sep. 2, 2024.

(30) Foreign Application Priority Data
Sep. 8, 2023 (CN) 202311165681.2

(51) Int. Cl. H04W 52/02; H04L 1/00; H04L 1/20

(52) U.S. Cl. CPC H04W 52/0235; H04L 1/0061; H04L 1/203

(57) ABSTRACT

This application discloses a receiving performance test method and apparatus, a terminal, and a network side device. The receiving performance test method in embodiments of this application includes: A terminal receives a first wake-up signal through a low power receiving module; and the terminal detects the first wake-up signal, to obtain a detection result, where the detection result is used to calculate a receiving error rate indicator value of the first wake-up signal, and a receiving performance indicator value of the low power receiving module is determined based on received power of the first wake-up signal whose receiving error rate indicator value meets a preset condition.

### CROSS-REFERENCE TO RELATED APPLICATIONS

This application is a U.S. national phase application of a PCT Application No. PCT/CN2024/116189 filed on Sep. 2, 2024, which claims priority to Chinese Patent Application No. 202311165681.2 filed in China on Sep. 8, 2023, which is incorporated herein by reference in its entirety.

### TECHNICAL FIELD

This application pertains to the field of communication technologies, and specifically relates to a receiving performance test method and apparatus, a terminal, and a network side device.

### BACKGROUND

In a related technology, to reduce power consumption of a terminal, a low power receiving module, for example, a low power wake-up receiver (LP-WUR) or an almost zero power wake-up receiver (AZP-WUR), is introduced in the terminal. The terminal enables the low power receiving module in an energy saving state to monitor a low power wake-up signal (LP-WUS), and a main communication module (or referred to as a main receiving module or a main receiver) of the terminal is in a disabled state or a sleep state. When downlink data arrives, a network side device sends a wake-up signal to the terminal. After detecting the wake-up signal through the low power receiving module, the terminal triggers the main communication module to be enabled or to be woken up after performing related determining.

Sensitivity of the receiver is unbalanced, which is an important indicator of performance of the receiver of the terminal. Currently, a manner of evaluating receiving performance (for example, receiving sensitivity) of the receiver of the terminal is applicable only to a loopback mode in which the receiver of the terminal works, that is, the receiver receives a signal from the network side device and feeds back the signal to the network side device. However, the low power receiving module does not work in the loopback mode. Therefore, a manner of evaluating the sensitivity of the receiver in the related technology is not applicable to evaluating the receiving performance of the low power receiving module. It may be learned that in the related technology, there is no corresponding solution for how to evaluate the receiving performance of the low power receiving module.

### SUMMARY

Embodiments of this application provide a receiving performance test method and apparatus, a terminal, and a network side device.

According to a first aspect, a receiving performance test method is provided. The method includes:
A terminal receives a first wake-up signal through a low power receiving module; and

the terminal detects the first wake-up signal, to obtain a detection result, where

the detection result is used to calculate a receiving error rate indicator value of the first wake-up signal, and a receiving performance indicator value of the low power receiving module is determined based on received power of the first wake-up signal whose receiving error rate indicator value meets a preset condition.

According to a second aspect, a receiving performance test apparatus is provided. The apparatus includes:
a first receiving module, configured to receive a first wake-up signal through a low power receiving module; and
a detection module, configured to detect the first wake-up signal, to obtain a detection result, where
the detection result is used to calculate a receiving error rate indicator value of the first wake-up signal, and a receiving performance indicator value of the low power receiving module is determined based on received power of the first wake-up signal whose receiving error rate indicator value meets a preset condition.

According to a third aspect, a receiving performance test method is provided. The method includes:
A network side device sends a first wake-up signal to a terminal, where the first wake-up signal is used to test receiving performance of a low power receiving module of the terminal; and
in a case that a receiving error rate indicator value of the first wake-up signal does not meet a preset condition, the network side device adjusts transmitted power of the first wake-up signal, and returns to perform the step of sending the first wake-up signal to the terminal, until the receiving error rate indicator value of the first wake-up signal meets the preset condition, where
a receiving performance indicator value of the low power receiving module is determined based on received power of the first wake-up signal whose receiving error rate indicator value meets the preset condition.

According to a fourth aspect, a receiving performance test apparatus is provided. The apparatus includes:
a sending module, configured to send a first wake-up signal to a terminal, where the first wake-up signal is used to test receiving performance of a low power receiving module of the terminal; and
an adjustment module, configured to: in a case that a receiving error rate indicator value of the first wake-up signal does not meet a preset condition, adjust transmitted power of the first wake-up signal, and return to perform the step of sending the first wake-up signal to the terminal, until the receiving error rate indicator value of the first wake-up signal meets the preset condition, where
a receiving performance indicator value of the low power receiving module is determined based on received power of the first wake-up signal whose receiving error rate indicator value meets the preset condition.

According to a fifth aspect, a terminal is provided. The terminal includes a processor and a memory, and the memory stores a program or an instruction that can be run on the processor; and when the program or the instruction is executed by the processor, the steps of the method according to the first aspect are implemented.

According to a sixth aspect, a terminal is provided. The terminal includes a processor and a communication interface. The communication interface is configured to receive a first wake-up signal; and the processor is configured to detect the first wake-up signal, to obtain a detection result, where the detection result is used to calculate a receiving error rate indicator value of the first wake-up signal, and a receiving performance indicator value of the low power receiving module is determined based on received power of the first wake-up signal whose receiving error rate indicator value meets a preset condition.

According to a seventh aspect, a network side device is provided. The network side device includes a processor and a memory, and the memory stores a program or an instruction that can be run on the processor; and when the program or the instruction is executed by the processor, the steps of the method according to the third aspect are implemented.

According to an eighth aspect, a network side device is provided. The network side device includes a processor and a communication interface. The communication interface is configured to send a first wake-up signal to a terminal, where the first wake-up signal is used to test receiving performance of a low power receiving module of the terminal; and the processor is configured to: in a case that a receiving error rate indicator value of the first wake-up signal does not meet a preset condition, adjust transmitted power of the first wake-up signal, and return to perform the step of sending the first wake-up signal to the terminal, until the receiving error rate indicator value of the first wake-up signal meets the preset condition, where a receiving performance indicator value of the low power receiving module is determined based on received power of the first wake-up signal whose receiving error rate indicator value meets the preset condition.

According to a ninth aspect, a receiving performance test system is provided. The receiving performance test system includes: a terminal and a network side device. The terminal may be configured to perform the steps of the receiving performance test method according to the first aspect, and the network side device may be configured to perform the steps of the receiving performance test method according to the third aspect.

According to a tenth aspect, a readable storage medium is provided. The readable storage medium stores a program or an instruction; and when the program or the instruction is executed by a processor, the steps of the method according to the first aspect are implemented, or the steps of the method according to the third aspect are implemented.

According to an eleventh aspect, a chip is provided. The chip includes a processor and a communication interface, the communication interface is coupled to the processor, and the processor is configured to run a program or an instruction, to implement the steps of the method according to the first aspect, or implement the steps of the method according to the third aspect.

According to a twelfth aspect, a computer program/program product is provided. The computer program/program product is stored in a storage medium, and the computer program/program product is executed by at least one processor, to implement the steps of the method according to the first aspect, or implement the steps of the method according to the third aspect.

### BRIEF DESCRIPTION OF DRAWINGS

FIG. 1 is a block diagram of a wireless communication system to which embodiments of this application are applicable;

FIG. 2 is a schematic diagram of a working principle of a low power wake-up module according to an embodiment of this application;

FIG. 3 is a schematic diagram of a low power wake-up signal according to an embodiment of this application;

FIG. 4 is a flowchart of a receiving performance test method according to an embodiment of this application;

FIG. 5 is a flowchart of another receiving performance test method according to an embodiment of this application;

FIG. 6 is a diagram of a structure of a receiving performance test apparatus according to an embodiment of this application;

FIG. 7 is a diagram of a structure of another receiving performance test apparatus according to an embodiment of this application;

FIG. 8 is a diagram of a structure of a communication device according to an embodiment of this application;

FIG. 9 is a diagram of a structure of a terminal according to an embodiment of this application; and

FIG. 10 is a diagram of a structure of a network side device according to an embodiment of this application.

### DESCRIPTION OF EMBODIMENTS

The following clearly describes technical solutions in embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this application are used to distinguish between similar objects, instead of describing a specific order or sequence. It should be understood that the terms used in such a way are interchangeable in proper circumstances, so that embodiments of this application can be implemented in an order other than the order illustrated or described herein. Objects classified by “first” and “second” are usually of a same type, and a quantity of objects is not limited. For example, there may be one or more first objects. In addition, “or” in this application represents at least one of connected objects. For example, “A or B” covers three solutions. To be specific, in a solution 1, A is included but B is not included; in a solution 2, B is included but A is not included; and in a solution 3, both A and B are included. The character “/” usually indicates an “or” relationship between associated objects.

The term “indication” in this application may be either a direct indication (or an explicit indication) or an indirect indication (or an implicit indication). The direct indication may be understood as that a sender explicitly notifies a receiver of content such as specific information, an operation that needs to be performed, or a request result in a sent indication. The indirect indication may be understood as that the receiver determines corresponding information based on an indication sent by the sender, or performs determining and determines an operation that needs to be performed, a request result, or the like based on a determining result.

It should be noted that the technologies described in the embodiments of this application are not limited to a long term evolution (LTE)/LTE-advanced (LTE-A) system, and may also be used in other wireless communication systems such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, or another system. The terms “system” and “network” in the embodiments of this application may be used interchangeably. The technologies described can be applied to both the systems and the radio technologies mentioned above as well as to other systems and radio technologies. A new radio (NR) system is described in the following descriptions for illustrative purposes, and the NR terminology is used in most of the following descriptions, although these technologies can also be applied to a system other than the NR system, for example, a 6^{th} generation (6G) communication system.

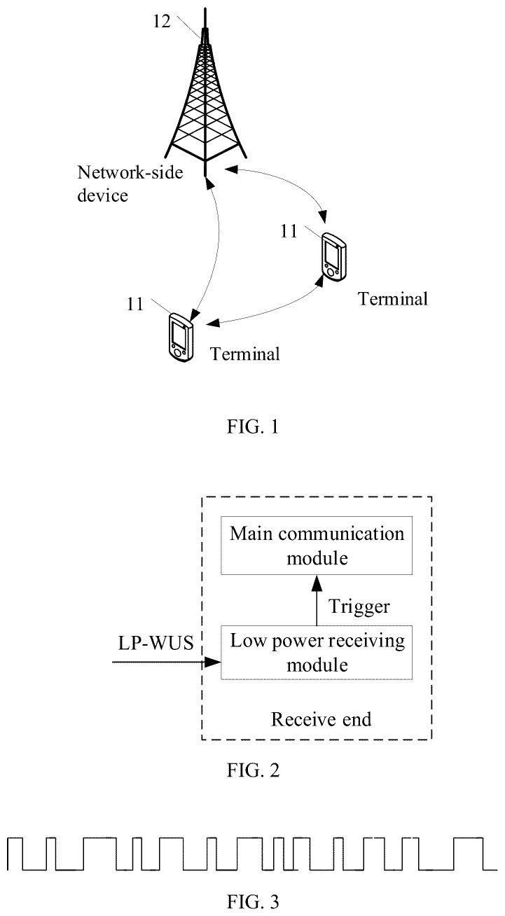

FIG. 1 is a block diagram of a wireless communication system to which embodiments of this application may be applied. The wireless communication system includes a terminal 11 and a network side device 12. The terminal 11 may be a terminal side device, for example, a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) device, a virtual reality (VR) device, a robot, a wearable device, a flight vehicle, vehicle user equipment (VUE), maritime user equipment, pedestrian user equipment (PUE), a smart home (a home device having a wireless communication function, for example, a refrigerator, a television, a washing machine, or furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart anklet chain, and the like), a smart wrist strap, smart clothes, and the like. A vehicle-mounted device may also be referred to as a vehicle-mounted terminal, a vehicle-mounted controller, a vehicle-mounted module, a vehicle-mounted component, a vehicle-mounted chip, or a vehicle-mounted unit. It should be noted that a specific type of the terminal 11 is not limited in the embodiments of this application. The network side device 12 may include an access network device or a core network device. The access network device may also be referred to as a radio access network (RAN) device, a radio access network function, or a radio access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB (gNB), a new radio NodeB (NR NodeB), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB, a transmission reception point (TRP), or another appropriate term in the field. Provided that same technical effect is achieved, the base station is not limited to a specified technical term. It should be noted that in the embodiments of this application, only a base station in an NR system is used as an example for description, and a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (Policy and Charging Rules Function, PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), and the like. It should be noted that in the embodiments of this application, only a core network device in an NR system is used as an example for description, and a specific type of the core network device is not limited.

For ease of understanding, some content involved in the embodiments of this application is described below.

### 1. Low Power Receiving Module

The low power receiving module, for example, a low power wake-up receiver or an almost zero power wake-up receiver, has a basic principle that a receive end of a terminal includes a first module and a second module. Specifically, as shown in FIG. 2, the first module is a main communication module (or referred to as a main receiving module, a main receiver, a main radio module, or the like), and is configured to send and receive mobile communication data, and the second module is a low power receiving module (also referred to as a low power wake-up receiving module), and is configured to receive the foregoing wake-up signal. The terminal enables the low power receiving module in an energy saving state to monitor a low power wake-up signal, and the main communication module is disabled or enters a sleep state. When downlink data arrives, a network sends a wake-up signal to the terminal. After detecting the wake-up signal by monitoring through the low power receiving module, the terminal triggers, after a series of determining, the main communication module from being disabled to being enabled or woken up. In this case, the low power receiving module enters a disabled state from a working state. The low power wake-up receiving module may be enabled continuously or intermittently, and may receive the low power wake-up signal when enabled.

### 2. Low Power Wake-Up Signal

To reduce receiving activities of the terminal in a standby state, and enable a radio frequency (RF) and a baseband module (for example, a baseband modem) to be truly disabled, thereby greatly reducing power consumption of communication receiving, a receiver with near “zero” power may be introduced into the receiving module of the terminal. The receiver with the near “zero” power does not need complex RF module signal detection (for example, amplification, filtering, and quantization) and baseband module signal processing, and only depends on passive matched filtering and signal processing with low power consumption.

On a base station side, a wake-up signal is triggered on-demand, so that the receiver with the near “zero” power can be activated to learn of an activation notification, thereby triggering a series of procedures inside the terminal, for example, enabling a radio frequency transceiver module and a baseband processing module.

Usually, the wake-up signal is a simple on-off keying signal, and a time-domain pattern of the on-off keying signal is shown in FIG. 3, so that the receiver can learn of a wake-up notification through a process such as simple energy detection and subsequent possible sequence detection and identification. In addition, when the terminal enables the low power wake-up receiver to receive the wake-up signal, the main receiving module may enter sleep or be disabled to maintain a low power level, to implement power consumption reduction by receiving the wake-up signal. The wake-up signal may alert the receiver that there is physical downlink control channel transmission or other communication.

### 3. Receiver Sensitivity

The receiver sensitivity (for example, reference sensitivity (REFSENS)) is a most basic and important indicator for measuring receiver performance of the terminal. The receiver sensitivity is defined as that radio frequency power on a reference measurement channel (RMC) meets a throughput≥95%.

An evaluation manner of the receiver sensitivity is as follows: The terminal is set in a loopback mode, the terminal establishes a connection to a base station simulator on a test channel, the base station simulator sends a downlink test signal (a reference measurement channel), a receiver of the terminal demodulates the received test signal and feeds back an acknowledgment (ACK)/negative acknowledgment (NACK), and the base station simulator continuously decreases downlink signal power until a receive throughput of the terminal reaches 95% of a theoretical maximum throughput, and records the downlink power received by a terminal side in this case.

With reference to the accompanying drawings, the following describes in detail a receiving performance test method provided in the embodiments of this application by using some embodiments and application scenarios.

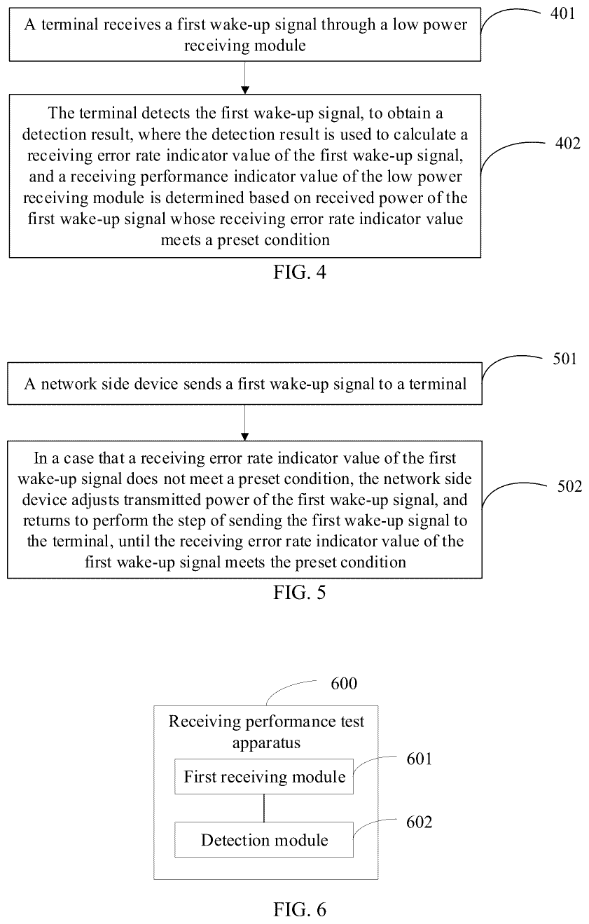

FIG. 4 is a flowchart of a receiving performance test method according to an embodiment of this application. The method may be performed by a terminal. As shown in FIG. 4, the method includes the following steps.

Step 401: A terminal receives a first wake-up signal through a low power receiving module.

In this embodiment, the low power receiving module may also be referred to as a low power wake-up receiver or an almost zero power wake-up receiver. For example, the terminal may receive, through the low power receiving module, the first wake-up signal sent by a network side device. The network side device may be a test device, a simulation device, or the like. For example, the network side device may be a base station simulator.

The first wake-up signal is a wake-up signal used to test receiving performance of the low power receiving module. For example, the first wake-up signal may reuse a low power wake-up signal (namely, an LP-WUS) in a related technology, or may be a specific wake-up signal, for example, a wake-up signal specially designed for testing. In addition, the first wake-up signal may include a first quantity of wake-up signals or a wake-up signal within first duration. The first quantity and the first duration may be properly set based on an actual requirement.

It should be noted that a main communication module of the terminal may not be woken up in a case that the first wake-up signal is received.

Step 402: The terminal detects the first wake-up signal, to obtain a detection result.

The detection result is used to calculate a receiving error rate indicator value of the first wake-up signal, and a receiving performance indicator value of the low power receiving module is determined based on received power of the first wake-up signal whose receiving error rate indicator value meets a preset condition.

In this embodiment, the foregoing receiving error rate indicator value may be used to represent a status of receiving the first wake-up signal by the foregoing low power receiving module. For example, the foregoing receiving error rate indicator value may include but is not limited to at least one of a block error rate (BLER), a bit error rate (BER), a miss detection rate, or the like.

The first wake-up signal is detected. For example, sequence detection may be performed on the first wake-up signal, to obtain a sequence detection result, and then the sequence detection result may be compared with a sending sequence corresponding to the first wake-up signal, to obtain the receiving error rate indicator value through calculation. Alternatively, a cyclic redundancy check (CRC) of the first wake-up signal may be calculated, and the CRC obtained through calculation based on the received first wake-up signal may be compared with a reference CRC, to obtain the receiving error rate indicator value through calculation, where the reference CRC may be a CRC obtained through calculation based on the first wake-up signal on a transmit side.

The receiving performance indicator value of the low power receiving module may be used to represent the receiving performance of the low power receiving module. For example, the receiving performance indicator value may include but is not limited to receiving sensitivity, reference sensitivity, or the like. The receiving error rate indicator value of the first wake-up signal meets the preset condition. For example, the receiving error rate indicator value of the first wake-up signal is less than or equal to a preset threshold. For example, the BLER of the first wake-up signal is less than or equal to 0.5%, 1%, 2%, 5%, 10%, or the like. In a case that the receiving error rate indicator value of the first wake-up signal meets the preset condition, the receiving performance indicator value of the low power receiving module is determined based on the received power of the first wake-up signal, that is, in a case that the receiving error rate indicator value of the first wake-up signal meets the preset condition, the receiving performance indicator value of the low power receiving module is determined based on the received power of the first wake-up signal, for example, the received power of the first wake-up signal is used as the receiving sensitivity of the low power receiving module.

It should be noted that in a case that the receiving error rate indicator value of the first wake-up signal currently received by the low power receiving module does not meet the preset condition, the low power receiving module may receive the first wake-up signal from the network side device again, until the receiving error rate indicator value of the first wake-up signal received by the low power receiving module meets the preset condition. It should be further noted that transmitted power of the first wake-up signal sent by the network side device to the terminal is different each time, and correspondingly received power of the first wake-up signal received by the terminal from the network side device is different each time.

According to the receiving performance test method provided in this embodiment of this application, the terminal receives the first wake-up signal through the low power receiving module; and the terminal detects the first wake-up signal, to obtain the detection result, where the detection result is used to calculate the receiving error rate indicator value of the first wake-up signal, and the receiving performance indicator value of the low power receiving module is determined based on the received power of the first wake-up signal whose receiving error rate indicator value meets the preset condition. In this way, the terminal receives, through the low power receiving module, the first wake-up signal sent by the network side device, detects the first wake-up signal, to obtain the detection result, and then calculates the receiving error rate indicator value of the first wake-up signal based on the detection result; and in a case that the receiving error rate indicator value of the first wake-up signal meets the preset condition, evaluates the receiving performance of the low power receiving module based on the received power of the first wake-up signal. This not only implements evaluation of the receiving performance of the low power receiving module, but also ensures accuracy of an evaluation result.

Optionally, the first wake-up signal includes a low power wake-up signal or a test-specific wake-up signal.

In an implementation, the low power wake-up signal (an LP-WUS) may be reused to test the receiving performance of the low power receiving module, and implementation is simple.

In another implementation, the test-specific wake-up signal may be designed to test the receiving performance of the low power receiving module, and flexibility is high.

Optionally, the receiving error rate indicator value includes at least one of the following: a block error rate BLER, a bit error rate BER, and a miss detection rate.

Optionally, the receiving performance indicator value includes receiving sensitivity or reference sensitivity (REFSENS).

It should be noted that the receiving performance indicator value of the low power receiving module may be obtained through a test in a conduction manner, or may be obtained through a test in an over the air (OTA) manner. The foregoing conduction manner may be understood as directly connecting a testing device (the network side device) to a tested device (the terminal) through a radio frequency cable, so that impact of an interference signal radiated in space on the test can be avoided. The foregoing OTA manner may be understood as that a signal is transmitted between the testing device and the tested device through an antenna. For example, the reference sensitivity may be received power at an antenna port in a case of testing in the conducted manner, and correspondingly the reference sensitivity of the low power receiving module may be, in a case that the receiving error rate indicator value of the first wake-up signal meets the preset condition, received power of the first wake-up signal at the antenna port in the case of testing in the conducted manner.

Optionally, that the terminal detects the first wake-up signal, to obtain a detection result of the first wake-up signal includes at least one of the following:
the terminal performs sequence detection on the first wake-up signal, to obtain a first detection result;
the terminal performs load detection on the first wake-up signal, to obtain a second detection result, where the load detection includes calculating a cyclic redundancy check CRC based on the first wake-up signal, and the second detection result includes the CRC;
the terminal detects the first wake-up signal based on an identifier of the terminal, to obtain a third detection result; and
the terminal detects the first wake-up signal based on an identifier of a group in which the terminal is located, to obtain a fourth detection result.

The following describes the embodiments of this application by using examples.

In an implementation, the terminal may perform sequence detection on the first wake-up signal, to obtain the first detection result, for example, a sequence detection result. In this case, the sequence detection result of the first wake-up signal may be compared with a sending sequence corresponding to the first wake-up signal, to calculate the receiving error rate indicator value of the first wake-up signal. In this way, it may be ensured that the receiving error rate indicator value obtained through calculation can accurately reflect a status of receiving the first wake-up signal.

In another implementation, the terminal may perform load detection on the first wake-up signal, for example, calculate the CRC based on the first wake-up signal, for example, calculate a CRC based on each bit sequence of the first wake-up signal, where each bit sequence includes at least two bits. Further, the CRC corresponding to each bit sequence may be compared with a reference CRC corresponding to each bit sequence, to calculate the receiving error rate indicator value of the first wake-up signal, where the reference CRC corresponding to the bit sequence may be the CRC obtained by the network side device through calculation based on a sending sequence corresponding to the bit sequence. In this implementation, the receiving error rate indicator value of the first wake-up signal is calculated based on the CRC of the first wake-up signal, so that accuracy of the receiving error rate indicator value obtained through calculation can be ensured, and detection complexity can be reduced.

In still another implementation, the terminal may detect the first wake-up signal based on an identifier of a terminal. For example, each bit sequence of the first wake-up signal carries the identifier of the terminal, and the low power receiving module may separately detect each bit sequence of the first wake-up signal based on the identifier of the terminal. In this way, the receiving error rate indicator value of the first wake-up signal may be calculated based on a quantity of identifiers, of the terminal, accurately detected by the low power receiving module. In this implementation, the receiving error rate indicator value of the first wake-up signal is calculated based on a result of detecting the first wake-up signal based on the identifier of the terminal, so that accuracy of the receiving error rate indicator value obtained through calculation can be ensured, and detection complexity can be reduced.

In still another implementation, the terminal may detect the first wake-up signal based on an identifier of a group in which the terminal is located. For example, each bit sequence of the first wake-up signal carries the identifier of the group in which the terminal is located, and the low power receiving module may separately detect each bit sequence of the first wake-up signal based on the identifier of the group in which the terminal is located. In this way, the receiving error rate indicator value of the first wake-up signal may be calculated based on a quantity of identifiers, of the group in which the terminal is located, accurately detected by the low power receiving module. In this implementation, the receiving error rate indicator value of the first wake-up signal is calculated based on a result of detecting the first wake-up signal based on the identifier of the group in which the terminal is located, so that accuracy of the receiving error rate indicator value obtained through calculation can be ensured, and detection complexity can be reduced.

Optionally, that the terminal detects the first wake-up signal, to obtain the detection result includes:
the terminal detects each bit of the first wake-up signal, to obtain a detection result corresponding to each bit; or
the terminal detects each bit sequence of the first wake-up signal, to obtain a detection result corresponding to each bit sequence, where each bit sequence includes at least two bits of the first wake-up signal; or
the terminal detects all bits of the first wake-up signal, to obtain the detection result corresponding to the first wake-up signal.

The following describes the embodiments of this application by using examples.

In an implementation, the terminal detects each bit of the first wake-up signal, to obtain the detection result corresponding to each bit. In this way, detection is performed based on a bit granularity, and each detection result reflects a status of receiving each bit.

In another implementation, the terminal detects each bit sequence of the first wake-up signal, to obtain the detection result corresponding to each bit sequence. In this way, detection is performed based on a bit sequence granularity, and each detection result may reflect a status of receiving each bit sequence.

In still another implementation, the terminal detects all bits of the first wake-up signal. In this way, detection is performed based on a granularity of the entire first wake-up signal, and the detection result may reflect a status of receiving the entire first wake-up signal. For example, the terminal performs sequence detection on all the bits of the first wake-up signal, to obtain the detection result, where the detection result includes detection values of all the bits of the first wake-up signal.

Optionally, the method further includes:
the terminal calculates the receiving error rate indicator value of the first wake-up signal based on the detection result; or
the terminal indicates the detection result to a network side device through a main communication module; or
the terminal outputs the detection result.

In an implementation, the terminal may calculate the receiving error rate indicator value of the first wake-up signal based on the detection result. For example, in a case that the detection result includes the sequence detection result of the first wake-up signal, the sequence detection result of the first wake-up signal may be compared with the sending sequence corresponding to the first wake-up signal, to calculate the receiving error rate indicator value of the first wake-up signal; or in a case that the detection result includes the CRC of each bit sequence of the first wake-up signal, the CRC corresponding to each bit sequence is compared with the reference CRC corresponding to each bit sequence, to calculate the receiving error rate indicator value of the first wake-up signal; or in a case that the detection result includes the detection result of the identifier, of the terminal, carried on each bit sequence of the first wake-up signal, the receiving error rate indicator value of the first wake-up signal may be calculated based on the quantity of identifiers, of the terminal, accurately detected by the low power receiving module; or in a case that the detection result includes the detection result of the identifier, of the group in which the terminal is located, carried on each bit sequence of the first wake-up signal, the receiving error rate indicator value of the first wake-up signal may be calculated based on the quantity of identifiers, of the group in which the terminal is located, accurately detected by the low power receiving module. The terminal may prestore at least one of the following before the test process starts: the sending sequence corresponding to the first wake-up signal, the reference CRC corresponding to each bit sequence of the first wake-up signal, the quantity of identifiers, of the terminal, carried in the first wake-up signal, and the quantity of identifiers, of the group in which the terminal is located, carried in the first wake-up signal.

Further, in a case that the receiving error rate indicator value, of the first wake-up signal, obtained through calculation meets the preset condition, the terminal may determine the receiving performance indicator value of the low power receiving module based on the received power of the first wake-up signal, for example, use the received power of the first wake-up signal as the receiving sensitivity of the low power receiving module. In a case that the receiving error rate indicator value, of the first wake-up signal, obtained through calculation does not meet the preset condition, the terminal may indicate the network side device to send the first wake-up signal to the terminal again. For example, the terminal may indicate, to the network side device through the main communication module, to send the first wake-up signal to the terminal again.

In another implementation, the terminal may indicate the detection result to the network side device through the main communication module, and further, the network side device may calculate the receiving error rate indicator value of the first wake-up signal based on the detection result. It should be noted that in a process of performing the receiving performance test on the low power receiving module, the main communication module of the terminal may always be in a wake-up state, or the main communication module of the terminal remains in a disabled state or a low power sleep state, and needs to be woken up by the low power receiving module.

In still another implementation, the terminal may output the detection result to an electronic device other than the network side device, and further, the electronic device may calculate the receiving error rate indicator value of the first wake-up signal based on the detection result. Further, in a case that the receiving error rate indicator value, of the first wake-up signal, obtained through calculation meets the preset condition, the electronic device may determine the receiving performance indicator value of the low power receiving module based on the receiving power of the first wake-up signal, for example, use the received power of the first wake-up signal as the receiving sensitivity of the low power receiving module, where the received power of the first wake-up signal may also be output by the terminal to the electronic device. It should be noted that, in a case that the receiving error rate indicator value of the first wake-up signal does not meet the preset condition, the electronic device may indicate the network side device to send the first wake-up signal to the terminal again. For example, the electronic device may indicate, to the network side device in a wired or wireless communication manner, to send the first wake-up signal to the terminal again.

Optionally, before the terminal indicates the detection result to the network side device through the main communication module, the method further includes:
the terminal wakes up the main communication module; and
the terminal establishes a connection to the network side device through the main communication module.

For example, the main communication module may remain in the disabled state or the low power sleep state in the process in which the low power receiving module receives the first wake-up signal, and the main communication module needs to be woken up by the low power receiving module. This helps reduce power consumption of the main communication module.

Optionally, that the terminal wakes up the main communication module includes:
the terminal wakes up the main communication module when receiving a second wake-up signal sent by the network side device; or
the terminal wakes up the main communication module after the low power receiving module completes receiving of the first wake-up signal; or
the terminal wakes up the main communication module after preset duration elapses from a first moment, where the first moment is a moment at which the low power receiving module completes receiving of the first wake-up signal or a moment at which the low power receiving module starts receiving the first wake-up signal.

In an implementation, the network side device may deliver a wake-up signal (a second wake-up signal) to wake up the main communication module. Specifically, after receiving, through the low power receiving module, the second wake-up signal sent by the network side device, the terminal may wake up the main communication module. In this way, the main communication module may establish the connection to the network side device, to indicate the detection result to the network side device.

In another implementation, the terminal may autonomously determine an occasion for waking up the main communication module. Specifically, the main communication module may be woken up after the low power receiving module completes receiving of the first wake-up signal, or the main communication module may be woken up after preset duration elapses from a first moment, where the preset duration may be properly set based on an actual requirement. For example, a timer may be started at a moment at which the low power receiving module starts to receive the first wake-up signal or ends receiving the first wake-up signal, where timing duration of the timer is the foregoing preset duration, and the main communication module of the terminal is woken up in a case that the timer expires.

Optionally, that the terminal indicates the detection result to a network side device through a main communication module includes:
the terminal sends the detection result to the network side device through the main communication module each time the detection result is obtained from the low power receiving module; or
the terminal sends a random access channel response to the network side device through the main communication module each time the detection result is obtained from the low power receiving module; or
the terminal sends the detection result to the network side device through the main communication module when obtaining a detection result corresponding to a first preset quantity of bit sequences or a bit sequence within first preset duration in the first wake-up signal.

In an implementation, each time the detection result is obtained from the low power receiving module, the obtained detection result may be sent to the network side device through the main communication module. For example, each time a detection result of one bit sequence of the first wake-up signal is detected, the low power receiving module may send the detection result of the bit sequence to the main communication module. Each time the main communication module receives a detection result of one bit sequence, the main communication module sends the detection result of the bit sequence to the network side device, so that real-time reporting of the detection result can be ensured.

In another implementation, each time the detection result is obtained from the low power receiving module, a random access channel (RACH) response may be sent to the network side device through the main communication module, so that the network side device can determine the detection result of the first wake-up signal based on a quantity of RACH responses. For example, the low power receiving module may send a detection result to the main communication module each time one bit whose value is 1 is detected, and the main communication module sends a RACH response to the network side device each time one detection result is received. In this way, the network side device may learn of, based on a quantity of RACH responses sent by the terminal, a quantity of bits whose values are 1 in the first wake-up signal. Further, the determined quantity of bits whose values are 1 may be compared with a quantity of bit sequences whose values are 1 in the sending sequence of the first wake-up signal, to calculate the receiving error rate indicator value of the first wake-up signal. In this manner, resource overheads for indicating the detection result to the terminal may be reduced.

In still another implementation, in a case that a detection result corresponding to a first preset quantity of bit sequences or a bit sequence within first preset duration is obtained, the detection result may be sent to the network side device through the main communication module. For example, in a case that detection results corresponding to 10 bit sequences are obtained, the detection results corresponding to the 10 bit sequences are sent to the network side device together; or in a case that detection results corresponding to bit sequences in 20 seconds are obtained, the detection results corresponding to the bit sequences in the 20 seconds are sent to the network side device together. This helps reduce resource overheads of indicating the detection result to the terminal.

Optionally, that the terminal outputs the detection result includes:
the terminal outputs the detection result by using an application; or
the terminal exports the detection result through an external bus interface.

In an implementation, the terminal may output the detection result to another electronic device by using the application. For example, the terminal may send the detection result to the another electronic device by using an installed communication application, or the terminal may send the detection result to the another electronic device by using an installed test-specific application.

In another implementation, the terminal may export the detection result to another electronic device through the external vertical interface, for example, export the detection result to the another electronic device through a universal serial bus (USB), a Type-C interface, or the like.

It should be noted that in a case in which the another electronic device obtains the detection result, the another electronic device may calculate the receiving error rate indicator value of the first wake-up signal based on the detection result, or the another electronic device may send the detection result to the network side device, and the network side device calculates the receiving error rate indicator value of the first wake-up signal based on the detection result.

Optionally, the first wake-up signal includes a first quantity of wake-up signals or a wake-up signal within first duration, the first quantity is greater than or equal to a second preset quantity, and the first duration is greater than or equal to second preset duration.

In this embodiment, the second preset quantity and the second preset duration may be properly set based on an actual situation. It may be understood that it is set that the first wake-up signal includes a quantity of wake-up signals that is greater than or equal to the second preset quantity or includes a wake-up signal within duration greater than or equal to the second preset duration, so that the receiving error rate indicator value obtained through calculation has better confidence.

Optionally, the second preset quantity or the second preset duration is determined based on a confidence requirement of the receiving error rate indicator value.

In this embodiment, the foregoing confidence level requirement may be properly set based on an actual requirement. For example, the confidence is greater than or equal to 95%. The second preset quantity or the second preset duration may be a minimum quantity or shortest duration that can enable the receiving error rate indicator value obtained through calculation to meet the confidence requirement.

Optionally, that the receiving error rate indicator value of the first wake-up signal meets the preset condition includes: the receiving error rate indicator value of the first wake-up signal is less than or equal to a preset threshold, or the receiving error rate indicator value of the first wake-up signal is within a preset threshold range.

In this embodiment, the preset threshold or the preset threshold range may be properly set based on an actual requirement. For example, the preset threshold may be 0.5%, 1%, 2%, 5%, 10%, or the like, and the preset threshold range may be a preset threshold ±X, where X may be properly set based on an actual situation, for example, 0.1% or 0.2%. For example, the preset threshold range may be [0.5%−0.1%, 0.5%+0.1%], [1%−0.2%, 1%+0.2%], or the like.

It should be further noted that the low power receiving module and the main communication module may be integrated together. For example, the low power receiving module is used as a part of the main communication module, or the low power receiving module and the main communication module may be two separate components.

FIG. 5 is a flowchart of a receiving performance test method according to an embodiment of this application. The method may be performed by a network side device. As shown in FIG. 5, the method includes the following steps.

Step 501: The network side device sends a first wake-up signal to a terminal, where the first wake-up signal is used to test receiving performance of a low power receiving module of the terminal.

Step 502: In a case that a receiving error rate indicator value of the first wake-up signal does not meet a preset condition, the network side device adjusts transmitted power of the first wake-up signal, and returns to perform the step of sending the first wake-up signal to the terminal, until the receiving error rate indicator value of the first wake-up signal meets the preset condition.

A receiving performance indicator value of the low power receiving module is determined based on received power of the first wake-up signal whose receiving error rate indicator value meets the preset condition.

For step 502, in a case that the network side device determines that the receiving error rate indicator value of the first wake-up signal does not meet the preset condition, the network side device may adjust the transmitted power of the first wake-up signal, and send the first wake-up signal to the terminal again by using the adjusted transmitted power; and if the receiving error rate indicator value of the first wake-up signal after the transmitted power is adjusted still does not meet the preset condition, adjust the transmitted power of the first wake-up signal again, and send the first wake-up signal to the terminal again by using the adjusted transmitted power, until the receiving error rate indicator value of the first wake-up signal after the transmitted power is adjusted meets the preset condition.

It should be noted that an initial value of the transmitted power of the first wake-up signal may be properly set based on an actual situation. In a case that the receiving error rate indicator value of the first wake-up signal does not meet the preset condition, the network side device may adjust the transmitted power of the first wake-up signal based on a preset power adjustment step. The preset power adjustment step is properly set based on an actual situation, for example, 0.5 dB or 0.25 dB.

Optionally, the first wake-up signal includes a low power wake-up signal or a test-specific wake-up signal.

Optionally, the receiving error rate indicator value includes at least one of the following: a block error rate BLER, a bit error rate BER, and a miss detection rate.

Optionally, the receiving performance indicator value includes receiving sensitivity or reference sensitivity.

Optionally, the method further includes:
the network side device receives a detection result, of the first wake-up signal, indicated by the terminal through the main communication module; and
the network side device determines the receiving error rate indicator value of the first wake-up signal based on the detection result of the first wake-up signal.

It should be noted that an implementation in which the network side device determines the receiving error rate indicator value of the first wake-up signal based on the detection result of the first wake-up signal may be the same as an implementation in which the terminal determines the receiving error rate indicator value of the first wake-up signal based on the detection result of the first wake-up signal. Details are not described herein.

Optionally, that the network side device receives a detection result, of the first wake-up signal, indicated by the terminal through the main communication module includes:
the network side device receives the detection result, of the first wake-up signal, sent by the terminal through the main communication module; or
the network side device receives a random access channel response sent by the terminal through the main communication module, where the random access channel response is used to indicate the detection result of the first wake-up signal.

Optionally, after the network side device sends the first wake-up signal to the terminal, the method further includes:
the network side device sends a second wake-up signal to the terminal, where the second wake-up signal is used to wake up the main communication module of the terminal.

Optionally, the first wake-up signal includes a first quantity of wake-up signals or a wake-up signal within first duration, the first quantity is greater than or equal to a second preset quantity, and the first duration is greater than or equal to second preset duration.

Optionally, the second preset quantity or the second preset duration is determined based on a confidence requirement of the receiving error rate indicator value.

Optionally, that the receiving error rate indicator value of the first wake-up signal meets the preset condition includes: the receiving error rate indicator value of the first wake-up signal is less than or equal to a preset threshold, or the receiving error rate indicator value of the first wake-up signal is within a preset threshold range.

It should be noted that for an implementation of this implementation, refer to related descriptions of the embodiment shown in FIG. 4. Details are not described herein again.

The following describes the embodiments of this application by using examples.

Example 1: To implement a fast test, the main communication module is in an enabled state or an on state and maintains a radio resource control (RRC) connection state with the network side device.

Step a1: The network side device delivers the first quantity of wake-up signals or the wake-up signal within the first duration, namely, the first wake-up signal, where the first wake-up signal may be a specific wake-up signal, or may be a conventional low power wake-up signal.

It should be noted that in a case that the network side device sends the first wake-up signal for the first time, the network side device may send the first wake-up signal based on initial power and a parameter configuration.

Step a2: The low power receiving module receives the first wake-up signal, performs detection, and indicates detection results to the main communication module.

Step a3: The main communication module reports the detection results successively; or accumulates a second quantity of pieces of low power wake-up signal detection indication information/low power wake-up signal detection indication information within second duration, and reports them together to the network side device.

Step a4: The network side device collects statistics on the BLER of the first wake-up signal based on the detection result, of the first wake-up signal received by the low power receiving module, reported by the main communication module.

Step a5: The network side device determines whether the BLER of the first wake-up signal reaches a preset threshold or is within a preset threshold range.

Step a6: If the BLER does not reach the preset threshold or is not within the preset threshold range, the network side device changes the transmitted power of the first wake-up signal, for example, may adjust the transmitted power of the first wake-up signal by using a fixed step such as 0.5 dB or 0.25 dB, and returns to perform step a1 based on the adjusted transmitted power, until the BLER of the sent first wake-up signal reaches the preset threshold or is within the preset threshold range, so that downlink signal power (the received power of the first wake-up signal whose BLER reaches the preset threshold or is within the preset threshold range) is receiving sensitivity of the low power receiving module.

Example 2: In a case that the low power receiving module measures the wake-up signal, the main communication module remains in a disabled state or a low power sleep state.

Step b1: The network side device delivers the first quantity of wake-up signals or the wake-up signal within the first duration, namely, the first wake-up signa.

This step is the same as the foregoing step a1. Details are not described herein again.

Step b2: The low power receiving module receives the first wake-up signal and performs detection, where the detection result is stored by the low power receiving module or indicated to the main communication module for storage. In this process, the main communication module remains in the disabled state or the low power sleep state.

Step b3: After step b2 is completed, the network side device triggers to wake up the main communication module (for example, delivers a second wake-up signal directly to wake up the main communication module, or wakes up the main communication module through the low power receiving module); and after being woken up, the main communication module is connected to the network side device and reports the detection result.

Alternatively, step b3: After step b2 is completed, the main communication module does not need to be triggered by the network side device, the low power receiving module starts the main communication module by timing, and the main communication module is connected to the network side device and reports the detection result.

Alternatively, step b3: After step b2 is completed, the detection result is exported in another manner, for example, by using a specific application or through a USB interface.

Step b4: The network side device collects statistics on the BLER of the first wake-up signal based on the detection result, of the first wake-up signal, reported by the main communication module to the network side device or the detection result, of the first wake-up signal, derived in another manner.

Step b5: The network side device determines whether the BLER of the first wake-up signal reaches a preset threshold or is within a preset threshold range.

Step b6: If the BLER does not reach the preset threshold or is not within the preset threshold range, the network side device changes the transmitted power of the first wake-up signal, and returns to perform step b1 based on the adjusted transmitted power, until the BLER of the sent first wake-up signal reaches the preset threshold or is within the preset threshold range, so that downlink signal power (the received power of the first wake-up signal whose BLER reaches the preset threshold or is within the preset threshold range) is receiving sensitivity of the low power receiving module.

Example 3: In a case that the low power receiving module measures the wake-up signal, the main communication module remains in a disabled state or a low power sleep state.

Step c1: The network side device delivers the first quantity of wake-up signals or the wake-up signal within the first duration, namely, the first wake-up signal.

This step is the same as the foregoing step a1. Details are not described herein again.

Step c2: The low power receiving module receives the wake-up signal, performs detection, and indicates the detection result to the main communication module.

Step c3: The main communication module successively sends the RACH response to the network side device based on the detection result in step c2.

Step c4: The network side device collects statistics on the BLER of the first wake-up signal based on a quantity of times that the main communication module sends the RACH response.

Step c5: The network side device determines whether the BLER of the first wake-up signal reaches a preset threshold or is within a preset threshold range.

Step c6: If the BLER does not reach the preset threshold or is not within the preset threshold range, the network side device changes the transmitted power of the first wake-up signal, and returns to perform step c1 based on the adjusted transmitted power, until the BLER of the sent first wake-up signal reaches the preset threshold or is within the preset threshold range, so that downlink signal power (the received power of the first wake-up signal whose BLER reaches the preset threshold or is within the preset threshold range) is receiving sensitivity of the low power receiving module.

It should be noted that the receiving performance test method provided in the embodiments of this application may be performed by a receiving performance test apparatus, or a control module in the receiving performance test apparatus for performing the receiving performance test method. In the embodiments of this application, the receiving performance test apparatus provided in the embodiments of this application is described by using an example in which the receiving performance test apparatus performs the receiving performance test method.

FIG. 6 is a diagram of a structure of a receiving performance test apparatus according to an embodiment of this application. As shown in FIG. 6, the receiving performance test apparatus 600 includes:
a first receiving module 601, configured to receive a first wake-up signal through a low power receiving module; and
a detection module 602, configured to detect the first wake-up signal, to obtain a detection result, where
the detection result is used to calculate a receiving error rate indicator value of the first wake-up signal, and a receiving performance indicator value of the low power receiving module is determined based on received power of the first wake-up signal whose receiving error rate indicator value meets a preset condition.

Optionally, the first wake-up signal includes a low power wake-up signal or a test-specific wake-up signal.

Optionally, the receiving error rate indicator value includes at least one of the following: a block error rate BLER, a bit error rate BER, and a miss detection rate.

Optionally, the receiving performance indicator value includes receiving sensitivity or reference sensitivity.

Optionally, the detection module is specifically configured to at least one of the following:
performing sequence detection on the first wake-up signal, to obtain a first detection result;
performing load detection on the first wake-up signal, to obtain a second detection result, where the load detection includes calculating a cyclic redundancy check CRC based on the first wake-up signal, and the second detection result includes the CRC;
detecting the first wake-up signal based on an identifier of a terminal, to obtain a third detection result; and
detecting the first wake-up signal based on an identifier of a group in which the terminal is located, to obtain a fourth detection result.

Optionally, the detection module is specifically configured to:
detect each bit of the first wake-up signal, to obtain a detection result corresponding to each bit; or
detect each bit sequence of the first wake-up signal, to obtain a detection result corresponding to each bit sequence, where each bit sequence includes at least two bits of the first wake-up signal; or
detect all bits of the first wake-up signal, to obtain the detection result corresponding to the first wake-up signal.

Optionally, the apparatus further includes:
a calculation module, configured to calculate the receiving error rate indicator value of the first wake-up signal based on the detection result; or
an indication module, configured to indicate the detection result to a network side device through a main communication module; or
an output module, configured to output the detection result.

Optionally, the apparatus further includes:
a wake-up module, configured to wake up the main communication module before the detection result is indicated to the network side device through the main communication module; and
a connection establishment module, configured to establish a connection to the network side device through the main communication module.

Optionally, the wake-up module is specifically configured to:
wake up the main communication module when receiving a second wake-up signal sent by the network side device; or
wake up the main communication module after the low power receiving module completes receiving of the first wake-up signal; or
wake up the main communication module after preset duration elapses from a first moment, where the first moment is a moment at which the low power receiving module completes receiving of the first wake-up signal or a moment at which the low power receiving module starts receiving the first wake-up signal.

Optionally, the indication module is specifically configured to:
send the detection result to the network side device through the main communication module each time the detection result is obtained from the low power receiving module; or
send a random access channel response to the network side device through the main communication module each time the detection result is obtained from the low power receiving module; or
send the detection result to the network side device through the main communication module when obtaining a detection result corresponding to a first preset quantity of bit sequences or a bit sequence within first preset duration in the first wake-up signal.

Optionally, the output module is specifically configured to:
output the detection result by using an application; or
export the detection result through an external bus interface.

Optionally, the first wake-up signal includes a first quantity of wake-up signals or a wake-up signal within first duration, the first quantity is greater than or equal to a second preset quantity, and the first duration is greater than or equal to second preset duration.

Optionally, the second preset quantity or the second preset duration is determined based on a confidence requirement of the receiving error rate indicator value.

Optionally, that the receiving error rate indicator value of the first wake-up signal meets the preset condition includes: the receiving error rate indicator value of the first wake-up signal is less than or equal to a preset threshold, or the receiving error rate indicator value of the first wake-up signal is within a preset threshold range.

The receiving performance test apparatus in this embodiment of this application may be an electronic device, for example, an electronic device with an operating system, or may be a component in the electronic device, for example, an integrated circuit or a chip. The electronic device may be a terminal, or another device that is not the terminal. For example, the terminal may include but is not limited to the foregoing listed types of the terminal 11, and the another device may be a server, a network attached storage (NAS), or the like. This is not specifically limited in this embodiment of this application.

The receiving performance test apparatus provided in this embodiment of this application can implement the processes of the method embodiment of FIG. 4, and same technical effect can be achieved. To avoid repetition, details are not described herein again.

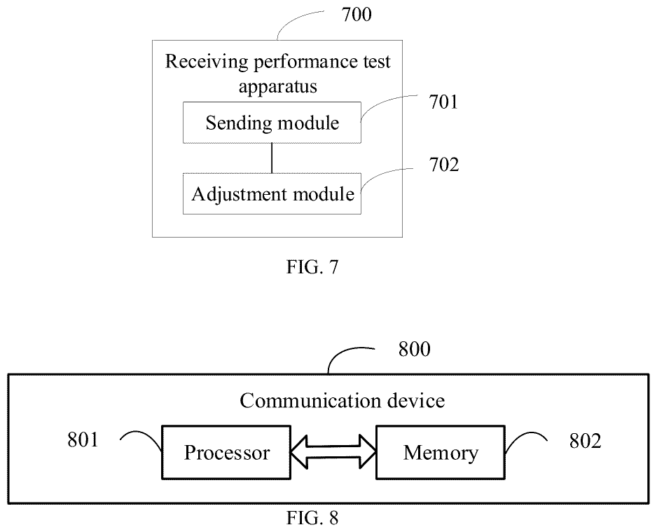

FIG. 7 is a diagram of a structure of a receiving performance test apparatus according to an embodiment of this application. As shown in FIG. 7, the receiving performance test apparatus 700 includes:
a sending module 701, configured to send a first wake-up signal to a terminal, where the first wake-up signal is used to test receiving performance of a low power receiving module of the terminal; and
an adjustment module 702, configured to: in a case that a receiving error rate indicator value of the first wake-up signal does not meet a preset condition, adjust transmitted power of the first wake-up signal, and return to perform the step of sending the first wake-up signal to the terminal, until the receiving error rate indicator value of the first wake-up signal meets the preset condition, where
a receiving performance indicator value of the low power receiving module is determined based on received power of the first wake-up signal whose receiving error rate indicator value meets the preset condition.

Optionally, the first wake-up signal includes a low power wake-up signal or a test-specific wake-up signal.

Optionally, the receiving error rate indicator value includes at least one of the following: a block error rate BLER, a bit error rate BER, and a miss detection rate.

Optionally, the receiving performance indicator value includes receiving sensitivity or reference sensitivity.

Optionally, the apparatus further includes:
a second receiving module, configured to receive a detection result, of the first wake-up signal, sent by the terminal through a main communication module; and
a determining module, configured to determine the receiving error rate indicator value of the first wake-up signal based on the detection result of the first wake-up signal.

Optionally, the second receiving module is specifically configured to:
receive the detection result, of the first wake-up signal, sent by the terminal through the main communication module; or
receive a random access channel response sent by the terminal through the main communication module, where the random access channel response is used to indicate the detection result of the first wake-up signal.

Optionally, the sending module is further configured to: after sending the first wake-up signal to the terminal, send a second wake-up signal to the terminal, where the second wake-up signal is used to wake up the main communication module of the terminal.

Optionally, the first wake-up signal includes a first quantity of wake-up signals or a wake-up signal within first duration, the first quantity is greater than or equal to a second preset quantity, and the first duration is greater than or equal to second preset duration.

Optionally, the second preset quantity or the second preset duration is determined based on a confidence requirement of the receiving error rate indicator value.

Optionally, that the receiving error rate indicator value of the first wake-up signal meets the preset condition includes: the receiving error rate indicator value of the first wake-up signal is less than or equal to a preset threshold, or the receiving error rate indicator value of the first wake-up signal is within a preset threshold range.

The receiving performance test apparatus in this embodiment of this application may be an electronic device, for example, an electronic device with an operating system, or may be a component in the electronic device, for example, an integrated circuit or a chip. The electronic device may be a network side device, or may be another device that is not the network side device. For example, the network side device may include but is not limited to the foregoing listed types of the network side device 12, and the another device may be a server, a network attached storage (NAS), or the like. This is not specifically limited in this embodiment of this application.

The receiving performance test apparatus provided in this embodiment of this application can implement the processes of the method embodiment of FIG. 5, and same technical effect can be achieved. To avoid repetition, details are not described herein again.

Optionally, as shown in FIG. 8, an embodiment of this application further provides a communication device 800. The communication device 800 includes a processor 801 and a memory 802, and the memory 802 stores a program or an instruction that can be run on the processor 801. For example, when the communication device 800 is a terminal, and the program or the instruction is executed by the processor 801, the steps of the foregoing receiving performance test method embodiment on the terminal side are implemented, and same technical effect can be achieved. When the communication device 800 is a network side device, and the program or the instruction is executed by the processor 801, the steps of the foregoing receiving performance test method embodiment on the network side device side are implemented, and same technical effect can be achieved. To avoid repetition, details are not described herein again.

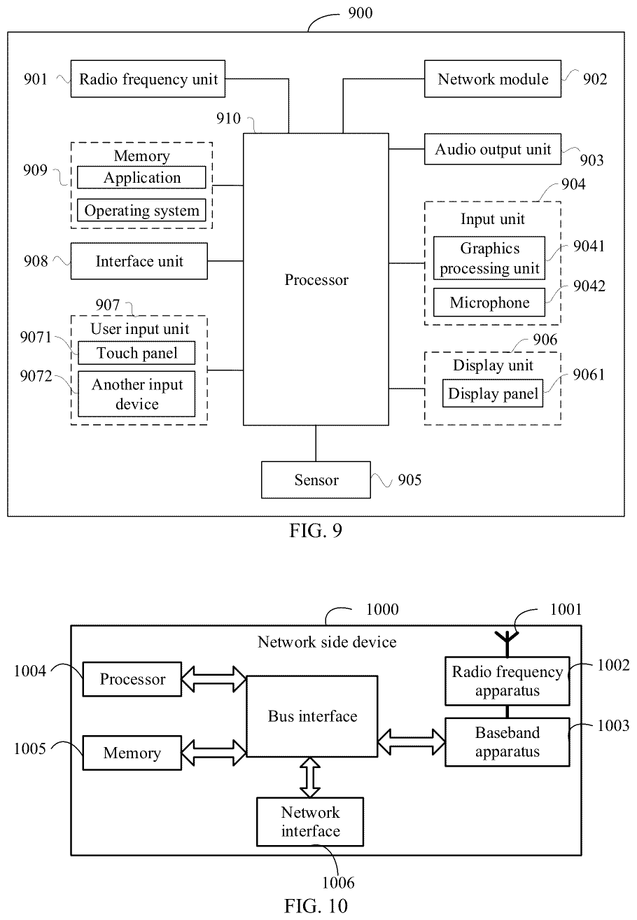

An embodiment of this application further provides a terminal. The terminal includes a processor and a communication interface. The communication interface is configured to receive a first wake-up signal; and the processor is configured to detect the first wake-up signal, to obtain a detection result, where the detection result is used to calculate a receiving error rate indicator value of the first wake-up signal, and a receiving performance indicator value of the low power receiving module is determined based on received power of the first wake-up signal whose receiving error rate indicator value meets a preset condition. The terminal embodiment corresponds to the method embodiment on the terminal side, each implementation process and implementation of the method embodiment can be applied to the terminal embodiment, and same technical effect can be achieved. Specifically, FIG. 9 is a schematic diagram of a hardware structure of a terminal according to an embodiment of this application.

The terminal 900 includes but is not limited to at least a part of components such as a radio frequency unit 901, a network module 902, an audio output unit 903, an input unit 904, a sensor 905, a display unit 906, a user input unit 907, an interface unit 908, a memory 909, and a processor 910.

A person skilled in the art can understand that the terminal 900 may further include a power supply (such as a battery) that supplies power to each component. The power supply may be logically connected to the processor 910 by using a power supply management system, to implement functions such as charging and discharging management, and power consumption management by using the power supply management system. The terminal structure shown in FIG. 9 constitutes no limitation on the terminal, and the terminal may include more or fewer components than those shown in the figure, or combine some components, or have different component arrangements. Details are not described herein.

It should be understood that in this embodiment of this application, the input unit 904 may include a graphics processing unit (GPU) 9041 and a microphone 9042. The graphics processing unit 9041 processes image data of a static picture or a video obtained by an image capture apparatus (for example, a camera) in a video capture mode or an image capture mode. The display unit 906 may include a display panel 9061, and the display panel 9061 may be configured in a form of a liquid crystal display, an organic light-emitting diode, or the like. The user input unit 907 includes at least one of a touch panel 9071 and another input device 9072. The touch panel 9071 is also referred to as a touchscreen. The touch panel 9071 may include two parts: a touch detection apparatus and a touch controller. The another input device 9072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 901 may transmit the downlink data to the processor 910 for processing. In addition, the radio frequency unit 901 may send uplink data to the network side device. Usually, the radio frequency unit 901 includes but is not limited to an antenna, an amplifier, a transceiver, a coupler, a low noise amplifier, a duplexer, and the like. The radio frequency unit 901 may include a low power receiving module and a main communication module.

The memory 909 may be configured to store a software program or an instruction and various data. The memory 909 may mainly include a first storage area for storing a program or an instruction and a second storage area for storing data. The first storage area may store an operating system, and an application or an instruction required by at least one function (for example, a sound playing function or an image playing function). In addition, the memory 909 may include a volatile memory or a nonvolatile memory. The nonvolatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 909 in this embodiment of this application includes but is not limited to these memories and any memory of another proper type.

The processor 910 may include one or more processing units. Optionally, an application processor and a modem processor are integrated into the processor 910. The application processor mainly processes an operating system, a user interface, an application, or the like. The modem processor mainly processes a wireless communication signal, for example, a baseband processor. It may be understood that, alternatively, the modem processor may not be integrated into the processor 910.

The radio frequency unit 901 is configured to receive a first wake-up signal.

The processor 910 is configured to detect the first wake-up signal, to obtain a detection result, where the detection result is used to calculate a receiving error rate indicator value of the first wake-up signal, and a receiving performance indicator value of the low power receiving module is determined based on received power of the first wake-up signal whose receiving error rate indicator value meets a preset condition.

Optionally, the first wake-up signal includes a low power wake-up signal or a test-specific wake-up signal.

Optionally, the receiving error rate indicator value includes at least one of the following: a block error rate BLER, a bit error rate BER, and a miss detection rate.

Optionally, the receiving performance indicator value includes receiving sensitivity or reference sensitivity.

Optionally, the processor 910 is specifically configured to perform at least one of the following:
performing sequence detection on the first wake-up signal, to obtain a first detection result;
performing load detection on the first wake-up signal, to obtain a second detection result, where the load detection includes calculating a cyclic redundancy check CRC based on the first wake-up signal, and the second detection result includes the CRC;
detecting the first wake-up signal based on an identifier of a terminal, to obtain a third detection result; and
detecting the first wake-up signal based on an identifier of a group in which the terminal is located, to obtain a fourth detection result.

Optionally, the processor 910 is specifically configured to:
detect each bit of the first wake-up signal, to obtain a detection result corresponding to each bit; or
detect each bit sequence of the first wake-up signal, to obtain a detection result corresponding to each bit sequence, where each bit sequence includes at least two bits of the first wake-up signal; or
detect all bits of the first wake-up signal, to obtain the detection result corresponding to the first wake-up signal.

Optionally, the processor 910 is configured to calculate the receiving error rate indicator value of the first wake-up signal based on the detection result; or

the radio frequency unit 901 is configured to indicate the detection result to the network side device through the main communication module; or

the processor 910 is configured to output the detection result.

Optionally, the processor 910 is further configured to wake up the main communication module before the detection result is indicated to the network side device through the main communication module.

The radio frequency unit 901 is further configured to establish a connection to the network side device through the main communication module.

Optionally, the processor 910 is specifically configured to:
wake up the main communication module when receiving a second wake-up signal sent by the network side device; or
wake up the main communication module after the low power receiving module completes receiving of the first wake-up signal; or
wake up the main communication module after preset duration elapses from a first moment, where the first moment is a moment at which the low power receiving module completes receiving of the first wake-up signal or a moment at which the low power receiving module starts receiving the first wake-up signal.

Optionally, the radio frequency unit 901 is specifically configured to:
send the detection result to the network side device through the main communication module each time the detection result is obtained from the low power receiving module; or
send a random access channel response to the network side device through the main communication module each time the detection result is obtained from the low power receiving module; or
send the detection result to the network side device through the main communication module when obtaining a detection result corresponding to a first preset quantity of bit sequences or a bit sequence within first preset duration in the first wake-up signal.

Optionally, the processor 910 is specifically configured to:
output the detection result by using an application; or
export the detection result through an external bus interface.

Optionally, the first wake-up signal includes a first quantity of wake-up signals or a wake-up signal within first duration, the first quantity is greater than or equal to a second preset quantity, and the first duration is greater than or equal to second preset duration.

Optionally, the second preset quantity or the second preset duration is determined based on a confidence requirement of the receiving error rate indicator value.

Optionally, that the receiving error rate indicator value of the first wake-up signal meets the preset condition includes: the receiving error rate indicator value of the first wake-up signal is less than or equal to a preset threshold, or the receiving error rate indicator value of the first wake-up signal is within a preset threshold range.

It may be understood that for an implementation process of the implementations in this embodiment, refer to related descriptions of the foregoing method embodiment, and same or corresponding technical effect may be achieved. To avoid repetition, details are not described herein again.

An embodiment of this application further provides a network side device. The network side device includes a processor and a communication interface. The communication interface is configured to send a first wake-up signal to a terminal, where the first wake-up signal is used to test receiving performance of a low power receiving module of the terminal; and the processor is configured to: in a case that a receiving error rate indicator value of the first wake-up signal does not meet a preset condition, adjust transmitted power of the first wake-up signal, and return to perform the step of sending the first wake-up signal to the terminal, until the receiving error rate indicator value of the first wake-up signal meets the preset condition, where a receiving performance indicator value of the low power receiving module is determined based on received power of the first wake-up signal whose receiving error rate indicator value meets the preset condition. The network side device embodiment corresponds to the method embodiment of the network side device, each implementation process and implementation of the method embodiment can be applied to the network side device embodiment, and same technical effect can be achieved.

Specifically, an embodiment of this application further provides a network side device. As shown in FIG. 10, the network side device 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes information that needs to be sent, and sends processed information to the radio frequency apparatus 1002. The radio frequency apparatus 1002 processes the received information, and sends processed information through the antenna 1001.

In the foregoing embodiment, the method performed by the network side device may be implemented in the baseband apparatus 1003. The baseband apparatus 1003 includes a baseband processor.

For example, the baseband apparatus 1003 may include at least one baseband board. A plurality of chips are disposed on the baseband board. As shown in FIG. 10, one chip is, for example, a baseband processor, and is connected to the memory 1005 through a bus interface, to invoke a program in the memory 1005 to perform the operations of the network device shown in the foregoing method embodiment.

The network side device may further include a network interface 1006, and the interface is, for example, a common public radio interface (CPRI).

Specifically, the network side device 1000 in this embodiment of this application further includes an instruction or a program that is stored in the memory 1005 and that can be run on the processor 1004. The processor 1004 invokes the instruction or the program in the memory 1005 to perform the method performed by the modules shown in FIG. 7, and same technical effect is achieved. To avoid repetition, details are not described herein again.

An embodiment of this application further provides a readable storage medium. The readable storage medium stores a program or an instruction; and when the program or the instruction is executed by a processor, the processes of the foregoing receiving performance test method embodiment are implemented, and same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, the processor is configured to run a program or an instruction, to implement the processes of the foregoing receiving performance test method embodiment, and same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, the computer program/program product is executed by at least one processor to implement the processes of the foregoing receiving performance test method embodiment, and same technical effect can be achieved. To avoid repetition, details are not described herein again.

An embodiment of this application further provides a receiving performance test system. The receiving performance test system includes a terminal and a network side device. The terminal is configured to perform processes in the method embodiments in FIG. 4, the network side device is configured to perform processes in the method embodiments in FIG. 5, and same technical effect can be achieved. To avoid repetition, details are not described herein again.

It should be noted that in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in embodiments of this application is not limited to performing functions in the order shown or discussed, but may also include performing the functions in a basically simultaneous manner or in opposite order based on the functions involved. For example, the described method may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiments may be implemented by using a computer software product in addition to a necessary universal hardware platform, or certainly may be implemented by hardware. The computer software product is stored in a storage medium (such as a ROM, a RAM, a magnetic disk, or an optical disc), and includes several instructions for instructing a terminal or a network side device to perform the method described in embodiments of this application.

Embodiments of this application are described above with reference to the accompanying drawings. However, this application is not limited to the foregoing specific implementations, and the foregoing specific implementations are merely illustrative and not limitative. Under the enlightenment of this application, a person of ordinary skill in the art can make many forms of implementations without departing from the purpose of this application and the protection scope of the claims, all of the implementations fall within the protection of this application.

1. A receiving performance test method, comprising:
receiving, by a terminal, a first wake-up signal through a low power receiving module; and
detecting, by the terminal, the first wake-up signal, to obtain a detection result, wherein the detection result is used to calculate a receiving error rate indicator value of the first wake-up signal, and a receiving performance indicator value of the low power receiving module is determined based on received power of the first wake-up signal whose receiving error rate indicator value meets a preset condition.

2. The method according to claim 1, wherein the first wake-up signal comprises a low power wake-up signal or a test-specific wake-up signal.

3. The method according to claim 1, wherein the receiving error rate indicator value comprises at least one of the following: a block error rate (BLER), a bit error rate (BER), or a miss detection rate.

4. The method according to claim 1, wherein the receiving performance indicator value comprises receiving sensitivity or reference sensitivity.

5. The method according to claim 1, wherein the detecting, by the terminal, the first wake-up signal, to obtain a detection result of the first wake-up signal comprises at least one of the following:
performing, by the terminal, sequence detection on the first wake-up signal, to obtain a first detection result;
performing, by the terminal, load detection on the first wake-up signal, to obtain a second detection result, wherein the load detection comprises calculating a cyclic redundancy check (CRC) based on the first wake-up signal, and the second detection result comprises the CRC;
detecting, by the terminal, the first wake-up signal based on an identifier of the terminal, to obtain a third detection result; or
detecting, by the terminal, the first wake-up signal based on an identifier of a group in which the terminal is located, to obtain a fourth detection result.

6. The method according to claim 1, wherein the detecting, by the terminal, the first wake-up signal, to obtain a detection result comprises:
detecting, by the terminal, each bit of the first wake-up signal, to obtain a detection result corresponding to each bit; or
detecting, by the terminal, each bit sequence of the first wake-up signal, to obtain a detection result corresponding to each bit sequence, wherein each bit sequence comprises at least two bits of the first wake-up signal; or
detecting, by the terminal, all bits of the first wake-up signal, to obtain the detection result corresponding to the first wake-up signal.

7. The method according to claim 1, wherein the method further comprises:
calculating, by the terminal, the receiving error rate indicator value of the first wake-up signal based on the detection result; or
indicating, by the terminal, the detection result to a network side device through a main communication module; or
outputting, by the terminal, the detection result.

8. The method according to claim 7, wherein before the indicating, by the terminal, the detection result to a network side device through a main communication module, the method further comprises:
waking up, by the terminal, the main communication module; and
establishing, by the terminal, a connection to the network side device through the main communication module.

9. The method according to claim 8, wherein the waking up, by the terminal, the main communication module comprises:
waking up, by the terminal, the main communication module when receiving a second wake-up signal sent by the network side device; or
waking up, by the terminal, the main communication module after the low power receiving module completes receiving of the first wake-up signal; or
waking up, by the terminal, the main communication module after preset duration elapses from a first moment, wherein the first moment is a moment at which the low power receiving module completes receiving of the first wake-up signal or a moment at which the low power receiving module starts receiving the first wake-up signal.

10. The method according to claim 7, wherein the indicating, by the terminal, the detection result to a network side device through a main communication module comprises:
sending, by the terminal, the detection result to the network side device through the main communication module each time the detection result is obtained from the low power receiving module; or
sending, by the terminal, a random access channel response to the network side device through the main communication module each time the detection result is obtained from the low power receiving module; or
sending, by the terminal, the detection result to the network side device through the main communication module when obtaining a detection result corresponding to a first preset quantity of bit sequences or a bit sequence within first preset duration in the first wake-up signal.

11. The method according to claim 7, wherein the outputting, by the terminal, the detection result comprises:
outputting, by the terminal, the detection result by using an application; or
exporting, by the terminal, the detection result through an external bus interface.

12. The method according to claim 1, wherein the first wake-up signal comprises a first quantity of wake-up signals or a wake-up signal within first duration, the first quantity is greater than or equal to a second preset quantity, and the first duration is greater than or equal to second preset duration.

13. The method according to claim 12, wherein the second preset quantity or the second preset duration is determined based on a confidence requirement of the receiving error rate indicator value.

14. The method according to claim 1, wherein that the receiving error rate indicator value of the first wake-up signal meets the preset condition comprises: the receiving error rate indicator value of the first wake-up signal is less than or equal to a preset threshold, or the receiving error rate indicator value of the first wake-up signal is within a preset threshold range.

15. A receiving performance test method, comprising:
sending, by a network side device, a first wake-up signal to a terminal, wherein the first wake-up signal is used to test receiving performance of a low power receiving module of the terminal; and
in a case that a receiving error rate indicator value of the first wake-up signal does not meet a preset condition, adjusting, by the network side device, transmitted power of the first wake-up signal, and returning to perform the step of sending the first wake-up signal to the terminal, until the receiving error rate indicator value of the first wake-up signal meets the preset condition, wherein
a receiving performance indicator value of the low power receiving module is determined based on received power of the first wake-up signal whose receiving error rate indicator value meets the preset condition.

16. The method according to claim 15, wherein the method further comprises:
receiving, by the network side device, a detection result, of the first wake-up signal, indicated by the terminal through the main communication module; and
determining, by the network side device, the receiving error rate indicator value of the first wake-up signal based on the detection result of the first wake-up signal.

17. The method according to claim 16, wherein the receiving, by the network side device, a detection result, of the first wake-up signal, indicated by the terminal through the main communication module comprises:
receiving, by the network side device, the detection result, of the first wake-up signal, sent by the terminal through the main communication module; or
receiving, by the network side device, a random access channel response sent by the terminal through the main communication module, wherein the random access channel response is used to indicate the detection result of the first wake-up signal.

18. The method according to claim 15, wherein after the sending, by a network side device, a first wake-up signal to a terminal, the method further comprises:
sending, by the network side device, a second wake-up signal to the terminal, wherein the second wake-up signal is used to wake up the main communication module of the terminal.

19. A terminal, comprising a processor and a memory, wherein the memory stores a program or an instruction that can be run on the processor; wherein the program or the instruction, when executed by the processor, causes the terminal to perform:
receiving a first wake-up signal through a low power receiving module; and
detecting the first wake-up signal, to obtain a detection result, wherein
the detection result is used to calculate a receiving error rate indicator value of the first wake-up signal, and a receiving performance indicator value of the low power receiving module is determined based on received power of the first wake-up signal whose receiving error rate indicator value meets a preset condition.

20. A network side device, comprising a processor and a memory, wherein the memory stores a program or an instruction that can be run on the processor; and when the program or the instruction is executed by the processor, the steps of the receiving performance test method according to claim 15 are implemented.
